(19) United States
(12) Patent Application Publication
(10) Pub. No.: US 2026/0155994 A1
(43) Pub. Date: Jun. 4, 2026

(54) ELECTRONIC DEVICE AND METHOD FOR PROCESSING SECURE DATA THEREOF

(71) Applicant: SAMSUNG ELECTRONICS CO., LTD., Suwon-si (KR)

(72) Inventor: Gawon LEE, Suwon-si (KR)

(73) Assignee: SAMSUNG ELECTRONICS CO., LTD., Suwon-si (KR)

(21) Appl. No.: 18/975,773

(22) Filed: Dec. 10, 2024

Related U.S. Application Data
(63) Continuation of application No. PCT/KR2024/015289, filed on Oct. 18, 2024.

(30) Foreign Application Priority Data
Oct. 11, 2023 (KR) 10-2023-0135046
Nov. 16, 2023 (KR) 10-2023-0159434

(51) Int. Cl. H04L 9/32; H04L 9/08; H04L 9/30

(52) U.S. Cl. CPC H04L 9/3247; H04L 9/0852; H04L 9/3013; H04L 9/3268

(57) ABSTRACT

Provided is a secure data processing method and device for performing same. The device includes: a communication circuit; a secure chipset; a memory storing instructions; and a processor configured to execute the instructions to: provide a first secure domain and a second secure domain, and wherein the processor is configured to execute the instructions to: receive a script forwarded from an external entity to the first secure domain through the communication circuit, obtain an authentication certificate and a digital signature of the external entity by parsing the script, cause the secure chipset to verify the authentication certificate by using a first authentication key related to the authentication certificate of the external entity stored in the first secure domain; extract a second authentication key from the authentication certificate; and cause the secure chipset to validate the digital signature by using the second authentication key.

### CROSS-REFERENCE TO RELATED APPLICATIONS

This application is a by-pass continuation of International Application No. PCT/KR 2024/015289, filed on Oct. 8, 2024, which is based on and claims priority to Korean Patent Application No. 10-2023-0135046 filed on Oct. 11, 2023 in the Korean Intellectual Property Office, and Korean Patent Application No. 10-2023-0159434 filed on Nov. 16, 2023 in the Korean Intellectual Property Office, the disclosures of which are incorporated by reference herein in their entireties.

### BACKGROUND

### 1. Field

The disclosure relates to an electronic device and, more particularly, to a method in which an electronic device processes secure data received from an external entity in a cryptosystem.

### 2. Description of Related Art

As various functions are provided on an electronic device, a method for safely protecting data stored in the electronic device is required. Accordingly, the electronic device may include a secure chipset (or a secure element integrated circuit (IC)) capable of protecting data requiring security from unreliable external sources. For example, the secure chipset ensures that internal keys and applications are safely protected by hardware, and may be used in various fields, such as a smart card, a subscriber identity module (SIM) card, a near-field communication (NFC) chip, and an embedded secure element (SE).

A service provider may perform secure operations, such as installing an applet on the secure chipset of the electronic device, configuring a policy, or implanting or obtaining a necessary value, in order to provide a service thereof. An example of a method used by the service provider as a secure operation for the secure chipset is a script method. The script method includes an encrypted command, and when the encrypted command is transmitted to the secure chip, the electronic device may decrypt the encrypted command to perform an operation corresponding to the command. In the script method, a script including the encrypted command may be included in a device code or be collectively downloaded through a server according to a specific demand, thereby being provided to the secure chipset. In this case, the script may be exposed by an untrusted attacker.

Since the command in the script is encrypted, an attacker without an encryption key is unable to identify the content of the command. For example, when the script is encrypted by an asymmetric key method, it is impossible for an external attacker having no private key to decrypt the command in the script. However, with the development and commercialization of quantum computer technology, the private key may be calculated using only a public key of an asymmetric key pair in a legacy cryptosystem using an asymmetric key pair based on elliptic curve cryptography. To solve this problem, post-quantum cryptography (or quantum-resistant cryptography, hereinafter referred to as PQC), which is capable of defending against an attack by a quantum computer, is being researched and standardized.

The above information is presented as background information only to assist with an understanding of the disclosure. No determination has been made, and no assertion is made, as to whether any of the above might be applicable as prior art with regard to the disclosure.

### SUMMARY

A PQC algorithm has a key with a very large size used for encryption and decryption, and may have lower performance than that of a legacy cryptographic algorithm. In the case of a secure chipset to which the PQC algorithm is applied, a defense mechanism may be applied to ensure safety from a subchannel attack, and a hardware accelerator may be applied, resulting in increased memory consumption. The secure chipset may have limited memory size and computing power, making it difficult to change all cryptosystems applied to the existing secure chipset to PQC systems.

Provided is an electronic device including a hybrid cryptosystem protected from an attack by a quantum computer while changing only some of the components of a secure chipset used in a legacy cryptosystem to components of a quantum cryptosystem, and a secure data processing method of the electronic device.

According to an aspect of the disclosure, an electronic device includes: a communication circuit; a secure chipset; at least one memory storing one or more instructions; and at least one processor operatively connected to the at least one memory, the communication circuit and the secure chipset, wherein the secure chipset is configured to execute the one or more instructions to: provide a plurality of secure domains including a first secure domain and a second secure domain, and wherein the at least one processor is configured to execute the one or more instructions to cause the electronic device to: receive a script forwarded from an external entity to the first secure domain through the communication circuit, obtain an authentication certificate and a digital signature of the external entity by parsing the script, cause the secure chipset to verify the authentication certificate by using a first authentication key related to the authentication certificate of the external entity stored in the first secure domain; extract a second authentication key from the authentication certificate; and cause the secure chipset to validate the digital signature by using the second authentication key.

The secure chipset may be further configured to execute the one or more instructions to: execute a key encapsulation mechanism (KEM) algorithm based on a post-quantum cryptography system.

The second secure domain may store a KEM public key and a KEM secret key used for the KEM algorithm.

The first secure domain may not store keys used for the KEM algorithm.

The KEM public key and the KEM secret key may be static keys implanted in a manufacturing process of the electronic device.

The script may include a first ciphertext, and the at least one processor may be configured to execute the one or more instructions to: based on the digital signature of the external entity being identified as being valid, obtain a random key by decapsulating the first ciphertext with the KEM secret key through the KEM algorithm executed by the secure chipset.

The script may further include a second ciphertext and an encrypted command, and the at least one processor may be configured to execute the one or more instructions to: obtain an elliptic curve Diffie-Hellman (ECDH) public key of the external entity by decrypting the second ciphertext with the random key, generate a session key through an ECDH algorithm by using the ECDH public key and an ECDH private key stored in the first secure domain, and decrypt the encrypted command with the session key.

The at least one processor may be configured to execute the one or more instructions to: obtain the ECDH public key using based an algorithm of a legacy cryptosystem, and generate the session key using the algorithm of the legacy cryptosystem.

According to an aspect of the disclosure, a secure data processing method of an electronic device includes: receiving a script forwarded from an external entity to a first secure domain among a plurality of secure domains of a secure chipset of the electronic device; obtaining an authentication certificate and a digital signature of the external entity by parsing the script; causing the secure chipset to verify the authentication certificate by using a first authentication key related to the authentication certificate of the external entity stored in the first secure domain; extracting a second authentication key from the authentication certificate; and causing the secure chipset to validate the digital signature by using the second authentication key.

The method may further include: causing the secure chipset to execute a key encapsulation mechanism (KEM) algorithm based on a post-quantum cryptography system.

A second secure domain of the secure chipset may store a KEM public key and a KEM secret key used for the KEM algorithm.

The first secure domain may not store keys used for the KEM algorithm.

The KEM public key and the KEM secret key may be static keys implanted in a manufacturing process of the electronic device.

The script may include a first ciphertext, and the method may further include, based on the digital signature of the external entity being identified as being valid, obtaining a random key by decapsulating the first ciphertext with the KEM secret key by executing the KEM algorithm through the secure chipset.

The script may further include a second ciphertext and an encrypted command, and the method may further include: obtaining an elliptic curve Diffie-Hellman (ECDH) public key of the external entity by decrypting the second ciphertext with the random key; generating a session key through an ECDH algorithm by using the ECDH public key and an ECDH private key stored in the first secure domain; and decrypting the encrypted command with the session key.

The obtaining of the ECDH public key and the generating of the session key may be based on an algorithm of a legacy cryptosystem.

According to an aspect of the disclosure, a non-transitory computer readable medium having instructions stored therein, which when executed by at least one processor, cause the at least one processor to execute a method of securely processing data processing by an electronic device, the method including: receiving a script forwarded from an external entity to a first secure domain among a plurality of secure domains of a secure chipset of the electronic device; obtaining an authentication certificate and a digital signature of the external entity by parsing the script; causing the secure chipset to verify the authentication certificate by using a first authentication key related to the authentication certificate stored in the first secure domain; extracting a second authentication key from the authentication certificate; and causing the secure chipset to validate the digital signature by using the second authentication key.

With regard to the method executed by the at least one processor based on the instructions stored in the non-transitory computer readable medium, the method may further include: causing the secure chipset to execute a key encapsulation mechanism (KEM) algorithm based on a post-quantum cryptography system.

With regard to the method executed by the at least one processor based on the instructions stored in the non-transitory computer readable medium, a second secure domain of the secure chipset may store a KEM public key and a KEM secret key used for the KEM algorithm.

With regard to the method executed by the at least one processor based on the instructions stored in the non-transitory computer readable medium, the script may include a first ciphertext, and the method may further include, based on the digital signature of the external entity being identified as being valid, obtaining a random key by decapsulating the first ciphertext with the KEM secret key by executing the KEM algorithm through the secure chipset.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an electronic device in a network environment according to one or more embodiments;

FIG. 2 illustrates an electronic device and external servers according to one or more embodiments;

FIG. 3 is a block diagram of an electronic device according to one or more embodiments;

FIG. 4 is a block diagram of a secure chipset of an electronic device according to one or more embodiments;

FIG. 5 is a flowchart illustrating a method in which an external entity generates a script according to one or more embodiments; and

FIG. 6 is a flowchart illustrating a method in which an electronic device processes a script according to one or more embodiments.

### DETAILED DESCRIPTION

Hereinafter, embodiments of the disclosure will be described in detail with reference to the accompanying drawings so that the embodiments may be readily implemented by those skilled in the art to which the disclosure pertains. However, the disclosure is not limited to the embodiments disclosed herein but can be realized in various other ways. In describing the drawings, the same or like reference numerals may be used to refer to the same or like elements. In the drawings and related descriptions, descriptions of well-known functions or components may be omitted for clarity and conciseness.

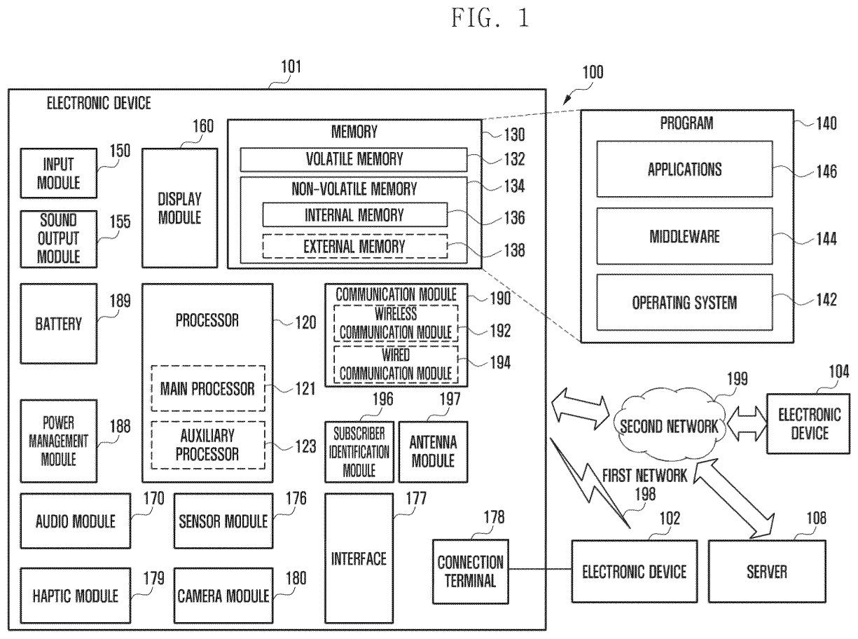

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In one or more embodiments, at least one of the components (e.g., the connecting terminal 178) may be omitted from the electronic device 101, or one or more other components may be added in the electronic device 101. In one or more embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one or more embodiments, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

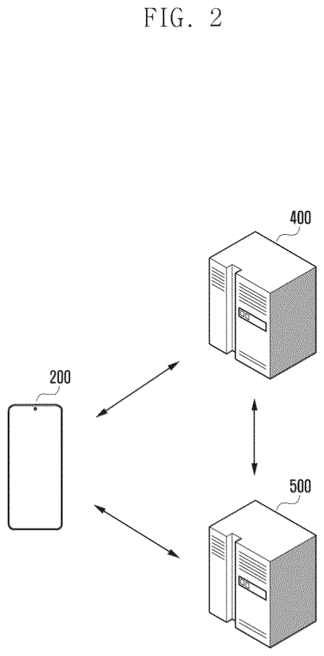

FIG. 2 illustrates an electronic device and external servers according to one or more embodiments.

According to an embodiment, the electronic device 200 is a portable electronic device, such as a smartphone or a tablet PC, and may provide various functions by using various applications. The electronic device 200 may include a secure chipset (or secure element IC) to protect data from unreliable external attacks. The secure chipset may ensure that keys and applications internally stored are safely protected in hardware.

According to an embodiment, an external entity 400 may be an entity outside the electronic device 200 that wishes to perform secure communication with the secure chipset of the electronic device 200. For example, the external entity 400 may be a service provider (e.g., a transportation card company and an ID management server) or a trusted service manager (TSM) entrusted with service operation by the service provider, and a secure element (SE) owner 500 may be the external entity 400. According to an embodiment, the external entity 400 may be a server device operated by the service provider, and may include a plurality of server devices. The external entity 400 may be assigned at least one secure domain within the secure chipset of the electronic device 200 to store various data, such as an applet.

According to an embodiment, the SE owner 500 may include at least one server device operated by a manufacturer of the electronic device 200. The SE owner 500 may implant a key used for encryption and decryption into the secure chipset of the electronic device 200 in a process. Further, the SE owner 500 may forward the key (e.g., a public key) implanted into the secure chipset at the request of the external entity 400.

When the secure chipset receives a command from the external entity 400, if the received command is not separately authenticated or verified, an operation may be performed by a command transmitted from an unspecified or unauthorized external source, and thus a malicious applet may be installed in the secure chipset and/or the secure chipset may perform a malicious operation. Therefore, the secure chipset may authenticate the external entity 400 when communicating with the external entity 400, and may establish a secure channel for protecting a channel message. The secure channel may be standardized by various methods, and the secure chipset of the electronic device 200 may be configured to operate through the standardized secure channel.

According to an embodiment, the secure chipset of the electronic device 200 may include a plurality of secure domains. The secure chipset may be loaded with a separate operating system (OS), and may be loaded with, for example, an operating system according to a card specification standard of Global Platform. The electronic device 200 may form the plurality of secure domains in the secure chipset according to the card specification standard of Global Platform, and may assign the respective secure domains to store data related to services of different external entities 400. Each secure domain may independently provide each service, may have a policy of not being able to access assets of other secure domains, and does not know or have access to keys of the other domains.

According to an embodiment, the external entity 400 may be assigned at least one secure domain from the secure chipset of the electronic device 200, and may perform secure operations, such as configuring a desired policy in the secure domain, implanting or obtaining a necessary value, or installing and executing an applet.

According to an embodiment, the external entity 400 may perform a secure operation on a secure domain according to a script method. For example, the script method may include Global Platform Secure Channel Protocol 11c (GP SCP11c), a secure element management system (SEMS), and local card contents management (LCCM), but is not limited thereto. The script method may include processes in which the external entity 400 assigned a specific secure domain may perform authentication, generation of a session key, and encryption of a command by using a public key of a static key pair stored in the secure domain and may transmit a script including generated pieces of data to the secure domain. When using the script method, the script generated by the external entity 400 may be transmitted to the secure chipset as it is without generating a dynamic or interactive communication message between the external entity 400 and the secure domain of the secure chipset, thereby performing a desired operation in the secure domain. Further, when using the script method, it is possible to forward and execute the script without network connection to a server operated by a service provider or an administrator of a target security domain (SD), thus enabling various applications.

According to an embodiment, the external entity 400 may forward the script to the secure chipset by including the encrypted command in a device code in the process of the electronic device 200 or collectively downloading the encrypted command through a sever according to the script method. In a process of forwarding the script or a state of storing the script in the secure chipset, the script may be exposed to an unreliable external attacker.

In legacy cryptosystems, even though the script is exposed to the attacker, the attacker is unable to discover the content of a command included in the script or to forge or falsify the script. For example, the script may include only the public key of the static key pair implanted into the security domain, a public key of a static key pair of the external entity 400, and/or a public key of a temporary key pair generated by the external entity 400, and may be encrypted and electronically signed with a session encryption key calculable only with a private key, and thus the attacker not having the private key is unable to discover or forge or falsify the encrypted data in the script.

As quantum computers using quantum mechanical principles are developed, the stability of a public key cryptosystem, such as RSA or elliptic curve cryptography (ECC), may be reduced. For example, if a quantum computer is developed, there is a risk of calculating a private key by using a public key of an ECC algorithm based on an elliptic curve. In this case, an attacker using a quantum computer may calculate a private key used for encryption in the script method, and may decode the content of a script or generate a valid script as that generated by the external entity 400 by using the private key. To compensate for the vulnerability of the legacy cryptosystem caused by the quantum computer, a post-quantum cryptography (hereinafter, “PQC) (or quantum-resistant cryptography) system is being developed. A PQC algorithm refers to various encryption algorithms not deciphered even by an attack attempt by the quantum computer, and Kyber, which is a key encapsulation mechanism (KEM) algorithm, and Dilithium, which is a PQC digital signature (DS) algorithm, are being standardized. The PQC algorithm has a key with a large size used for encryption and decryption, and may have lower performance than that of the legacy cryptosystem. Further, in the case of a secure chipset to which the PQC algorithm is applied, a defense mechanism may be applied to ensure safety from a subchannel attack, and a hardware accelerator may be applied, resulting in increased memory consumption. Accordingly, it may be difficult to apply the PQC algorithm to a secure chipset of the electronic device 200 with limited memory size and computing power.

In consideration of the foregoing problems, the electronic device 200 according to one or more embodiments of the disclosure may provide a secure service according to a quantum-safe script method (or safe from an attack by a quantum computer) while maintaining a structure implemented in the legacy cryptosystem for the secure chipset as much as possible and minimizing changes to the operating system of the secure chipset.

According to an embodiment, the secure chipset of the electronic device 200 may store one key pair used in the PQC KEM algorithm. Further, the electronic device 200 may store a module that performs an algorithm for verifying a digital signature of the PQC DS algorithm. The electronic device 200 may include the structure of the legacy cryptosystem except for the key pair and the module, and may prevent the script from being exposed to an attack by a quantum computer even with this configuration.

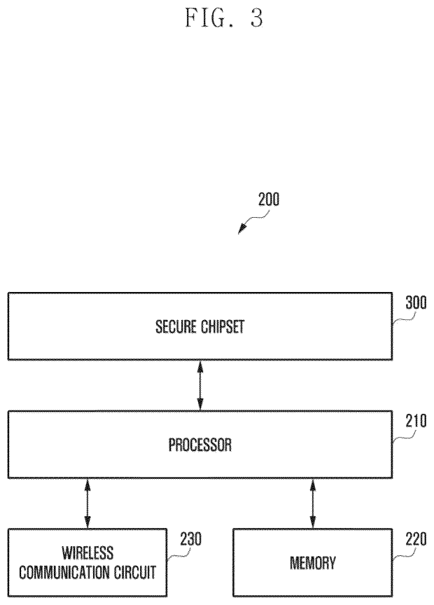

FIG. 3 is a block diagram of an electronic device according to one or more embodiments.

Referring to FIG. 3, the electronic device 200 may include a secure chipset 300, a wireless communication circuit 230, a processor 210, and a memory 220. One or more embodiments of the disclosure may be implemented even though at least some of the illustrated components are omitted or replaced. The electronic device 200 may further include at least some of the components and/or functions of the electronic device 101 of FIG. 1.

According to an embodiment, the wireless communication circuit 230 may support wireless communication with an external device (e.g., the external entity 400 of FIG. 2). For example, the wireless communication circuit 230 may include various hardware and software components to support cellular wireless communication (e.g., 4G LTE and 5G NR) and short-range wireless communication (e.g., WLAN and Bluetooth). The wireless communication circuit 230 may include at least some of the components and/or functions of the communication module 190 of FIG. 1. According to an embodiment, the wireless communication circuit 230 may receive secure data (e.g., a script) from the external entity by an over-the-air (OTA) method.

According to an embodiment, the memory 220 may include a volatile memory and a non-volatile memory, and may temporarily or permanently store various data. The memory 220 may include at least some of the components and/or functions of the memory 130 of FIG. 1, and may store the program 140 of FIG. 1. The memory 220 may store various instructions executable by the processor 210. The instructions may include control commands for arithmetic and logical operations, data movement, and input/output recognizable by the processor 210.

According to an embodiment, the processor 210 is a component capable of performing operations or data processing related to control and/or communication of each component of the electronic device 200, and may include one or more processors. The processor 210 may include at least some of the components and/or functions of the processor 120 of FIG. 1. The processor 210 may be operatively, functionally, and/or electrically connected to each component of the electronic device 200, such as the wireless communication circuit 230, the memory 220, and the secure chipset 300.

In an embodiment, pieces of hardware of the electronic device 200 being operatively coupled may mean that a direct connection or an indirect connection between the pieces of hardware is established via a cable or wirelessly such that a second piece of hardware among the pieces of hardware is controlled by a first piece of hardware. Although there is no restriction in operations and data processing functions that the processor 210 is capable of implementing on the electronic device 200, one or more embodiments for receiving a script from an external entity, generating an encryption key by using the script and a key implanted in advance in the secure chipset 300, and/or executing a command by decrypting the encrypted command will be described in the disclosure. The following operations of the processor 210 may be performed by loading the instructions stored in the memory 220. According to an embodiment, at least some of the following operations of the processor 210 may be performed by a security processor included in the secure chipset 300.

According to an embodiment, the secure chipset (secure element) 300 may include a circuit configuration and software that ensure an environment for safe storage of data and execution of a protected command. According to an embodiment, the secure chipset 300 may be configured as a separate chipset from the processor 210 and the memory 220. According to another embodiment, a physical portion of the memory 220 may be assigned as the area of the secure chipset 300. The secure chipset 300 may also be referred to as a secure element IC or secure circuitry.

According to an embodiment, the secure chipset 300 may store and execute an operating system independent of an operating system executed by the processor 210. For example, the operating system of the secure chipset 300 may follow the card specification standard of Global Platform.

According to an embodiment, the secure chipset 300 may include a plurality of secure domains. The plurality of secure domains may be assigned to physically or logically separate areas on the secure chipset 300. Each secure domain may independently provide a service of each external entity (e.g., a transportation card company and an ID management server), and may have a policy of not being able to access assets of other secure domains, and not knowing keys of the other domains keys.

According to an embodiment, the plurality of secure domains may include a first secure domain configured to store an applet related to a service of a specific external entity and to execute a command included in a script received from the external entity and a second secure domain configured to manage an operation of other secure domains in the secure chipset 300 and to manage and distribute an encryption key. The number of secure domains included in the secure chipset 300 is not limited to the above example, and at least one secure domain corresponding to a function and an operation of the first secure domain may be assigned on the secure chipset 300 to provide a service of at least one different external entity.

According to an embodiment, the second secure domain may be a controlling authority security domain (CASD). The CASD may generate an initial key to a newly generated secure domain, or may provide a signature for attestation when providing attestation of the secure chipset 300 of a service applet of another secure domain to the external entity. The second secure domain is described as the CASD in the disclosure, but is not limited thereto.

According to an embodiment, the second secure domain (e.g., the CASD) may store an asymmetric key pair of KEM.PK (or KEM public key) and KEM.SK (or KEM secret key) used in a post-quantum cryptography (PQC) key encapsulation mechanism (KEM) algorithm. The asymmetric key pair of KEM.PK and KEM.SK stored in the second secure domain may be implanted in a manufacturing process of the secure chipset 300, may be implanted in the secure chipset 300 in a manufacturing process of the electronic device 200, or may be received by an OTA method through the wireless communication circuit 230 while the electronic device 200 is used by a user and be implanted. According to an embodiment, KEM.PK and KEM.SK in the asymmetric key pair may be static keys generated by an SE owner, and for example, the SE owner may implant the same PQC key pair as static keys into the secure chipset 300 of a plurality of electronic devices by the model of each electronic device 200 or the operating system of each SE card.

According to an embodiment, the first secure domain may decrypt a ciphertext by using the PQC KEM key pair stored in the second secure domain. For example, a designated interface (e.g., a sharable interface object (SIO)) may be formed between the first secure domain and the second secure domain, and the first secure domain may request decapsulation using at least one key of the PQC KEM asymmetric key pair stored in the second secure domain through invoking of an SIO API. In response to a request for decapsulation, the second secure domain may obtain a random key as a value resulting from the decapsulation using the KEM secret key of the KEM asymmetric key pair, and may transmit the obtained random key to the first secure domain through the SIO. The PQC KEM keys are larger than asymmetric keys of a legacy cryptosystem, but the secure chipset 300 may store the PQC KEM key pair only in the second secure domain, thus reducing resources of the memory 220 required to store the keys.

According to an embodiment, the secure chipset 300 may include a PQC KEM module and a PQC digital signature verification module. According to an embodiment, the PQC KEM module may include a library, a package, or a module for a KEM algorithm configured in the secure chipset 300. The PQC KEM module may perform key encapsulation or decapsulation of the KEM algorithm, such as Kyber. According to an embodiment, the PQC digital signature verification module may include a library, a package, or a module that provides a signature verification function among PQC electronic digital algorithm functions configured in the secure chipset 300. The PQC digital signature verification module may implement a quantum-safe (or safe from an attack by a quantum computer) digital signature algorithm, such as Dilithium.

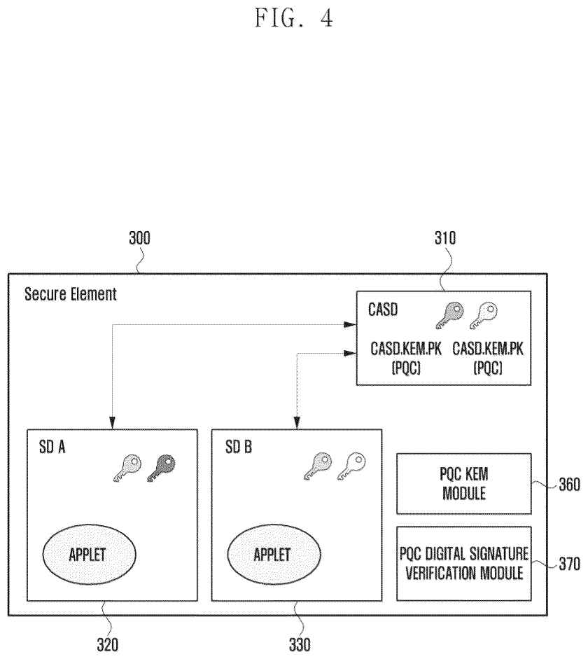

A specific configuration of the secure chipset 300 including the plurality of secure domains, the PQC KEM module, and the PQC digital signature verification module will be described in more detail with reference to FIG. 4.

According to an embodiment, the electronic device 200 may receive a script including a command from the external entity. Hereinafter, an operation of the processor 210 (or a security processor of the secure chipset 300) when receiving a script targeted at the first secure domain from the external entity will be described.

According to an embodiment, the processor 210 (or the security processor of the secure chipset 300) may parse an authentication certificate, a digital signature, a plurality of ciphertexts, and encrypted commands of the external entity from the received script.

According to an embodiment, the processor 210 may verify the authentication certificate of the external entity by using a public key of an off-card entity (OCE) authentication certificate issuer (e.g., an issuer or CA) obtained in advance through the PQC digital signature verification module. The electronic device 200 may obtain the public key in advance from the issuer (e.g., the issuer or CA) that issues the authentication certificate of the external entity in order to verify a digital signature authentication certificate held by the external entity. For example, the public key of the OCE authentication certificate issuer may be implanted in advance into the secure chipset through a process of the secure chipset 300, a process of the electronic device 200, and/or an OTA service operated by the SE owner. Since the external entity electronically signs using a PQC digital signature algorithm and a key, the authentication certificate of the external entity may be trusted not to be attacked by a quantum computer.

According to an embodiment, the processor 210 may verify the digital signature of the external entity by using a public key extracted from the authentication certificate of the external entity through the PQC digital signature verification module. When verification is successful, the electronic device 200 may trust that the script is signed by the external entity.

According to an embodiment, the processor 210 may decapsulate a first ciphertext parsed from the script through the PQC KEM module by using the KEM secret key stored in the second secure domain, and may obtain a random key K. For example, the processor 210 may request decapsulation using the KEM secret key from the second secure domain by invoking the SIO API between the first secure domain and the second secure domain, and the second secure domain may obtain the random key K as a value resulting from the decapsulation using the KEM secret key. The first ciphertext may be obtained by encapsulating a random key that the external entity generates by using the KEM public key that is paired with the KEM secret key, and the same random key as the random key generated by the external entity may be obtained by decapsulating the first ciphertext by the same PQC KEM algorithm as that of the external entity through the PQC KEM module.

According to an embodiment, the processor 210 may decrypt a second ciphertext parsed from the script by using the random key obtained by decapsulation by the PQC KEM module, and may obtain a public key of a temporary elliptic curve Diffie-Hellman (ECDH) key pair generated by the external entity. The public key of the temporary ECDH key pair generated by the external entity may be encrypted with a random key after being generated and then be decrypted in the secure chipset 300 of the electronic device 200, thus being quantum-safe (or safe from an attack by a quantum computer).

According to an embodiment, the processor 210 may generate a session key by using the obtained ECDH public key of the external entity and an ECDH private key stored in the first secure domain. An algorithm for generating the session key may be an elliptic curve Diffie-Hellman (ECDH) algorithm of the legacy cryptosystem. The external entity may generate a session key by using an ECDH secret key generated thereby and an ECDH public key stored in the first secure domain of the electronic device 200, and may encrypt the ciphertext of the command included in the script with the session key generated by the external entity. Since the electronic device 200 generates the session key by using the ECDH public key of the external entity and the ECDH private key of the first secure domain through the same ECDH algorithm as that of the external entity, the session key generated by the electronic device 200 and the session key generated by the external entity may be the same.

According to an embodiment, the processor 210 may decrypt the encrypted command by using the generated session key. The command is encrypted by the external entity using a symmetric key encryption method using the session key, and the session key generated by the electronic device 200 is the same as the session key generated by the external entity, and thus the encrypted command may be decrypted with the session key. A process in which the processor 210 generates the session key and decrypts the command may employ a method of the legacy cryptosystem instead of using a PQC system. Therefore, even though including only the configuration of the legacy cryptosystem not including quantum-safe hardware and/or software to generate the session key and decrypt the command, the electronic device 200 may provide a quantum-safe environment in which the script is not exposed by an attack by a quantum computer.

According to an embodiment, the processor 210 may execute the decrypted command. For example, the processor 210 may install and operate an applet configured in the command, and/or may execute a policy determined in the command in the first secure domain, which is a target secure domain.

FIG. 4 is a block diagram of a secure chipset of an electronic device according to one or more embodiments.

Referring to FIG. 4, the secure chipset 300 (secure element) (e.g., the secure chipset 300 of FIG. 3) may include a plurality of secure domains 310, 320, and 330, a PQC KEM module 360, and a PQC digital signature verification module 370.

According to an embodiment, the secure chipset 300 may be loaded with an operating system (e.g., an operating system according to a card specification of Global Platform) independent of an operating system operated by a processor (e.g., the processor 210 of FIG. 3) of the electronic device. The operating system of the secure chipset 300 may assign a plurality of secure domains (SDs). Each secure domain (e.g., a CASD 310, SD A 320, and SD B 330) may be assigned to physically or logically separate areas on the secure chipset 300. Each secure domain 310, 320, and 330 may independently provide each service, may have a policy of not being able to access assets of other secure domains, and do not know keys of the other domains.

According to an embodiment, the controlling authority security domain (CASD) 310 may manage operations of generating, deleting, and updating other secure domains within the secure chipset 300, may be responsible for key management within the secure chipset 300, and may distribute a key to other security domains. The CASD 310 may generate an initial key to a newly generated secure domain, or may provide a signature for attestation when providing attestation of the secure chipset 300 of a service applet of another secure domain to an external entity.

According to an embodiment, the CASD 310 may store an asymmetric key pair of KEM.PK (or KEM public key) and KEM.SK (or KEM secret key) used in a post-quantum cryptography (PQC) key encapsulation mechanism (KEM) algorithm. The KEM (or key encapsulation mechanism) algorithm may be an encryption technology that combines a symmetric key encryption method and a public key encryption method to enable a secure key exchange between a sender and a receiver of a message.

According to an embodiment, the asymmetric key pair of KEM.PK and KEM.SK stored in the CASD 310 may be implanted in a manufacturing process of the secure chipset 300, may be implanted in the secure chipset 300 in a manufacturing process of the electronic device, or may be received by an OTA method through the wireless communication circuit while the electronic device is used by a user and be implanted. According to an embodiment, KEM.PK and KEM.SK in the asymmetric key pair may be static keys generated by an SE owner (e.g., the SE owner 500 of FIG. 2). For example, the SE owner may implant the same PQC key pair as static keys into the secure chipset 300 of a plurality of electronic devices by the model of each electronic device or the operating system of each SE card. Accordingly, an external entity assigned a specific secure domain (e.g., SD A 320) of the secure chipset 300 may request the SE owner to forward a key, including information about the model of the electronic device or the operating system of the secure chipset 300, and may obtain the KEM public key KEM.PK from the SE owner.

According to another embodiment, the asymmetric key pair of KEM.PK and KEM.SK may be stored in a secure domain other than the CASD 310. In the disclosure, a secure domain (e.g., the CASD 310 or another secure domain) that stores KEM.PK and KEM.SK used for a PQC KEM algorithm may be referred to as a second secure domain.

According to an embodiment, SD A 320 and SD B 330 may be secure domains assigned corresponding to services of respective external entities in the secure chipset 300. Although FIG. 4 shows two secure domains, SD A 320 and SD B 330, the number of secure domains assignable in the secure chipset 300 is not limited thereto.

According to an embodiment, SD A 320 and SD B 330 may store at least one applet. An applet may refer to a small-scale application executed on a small-capacity computer device, such as a secure domain. According to an embodiment, SD A 320 and SD B 330 may independently provide services of different external entities, may a policy of not being able to access assets of other secure domains, and do not know keys of the other secure domains. According to an embodiment, SD A 320 and SD B 330 may store a key pair used for an elliptic curve Diffie-Hellman (ECDH) algorithm, which is a legacy cryptosystem.

According to an embodiment, SD A 320 and SD B 330 may install and execute the applet, based on a command transmitted from each corresponding external entity, and may perform an operation, such as configuring a policy for the applet and updating the applet. According to an embodiment, SD A 320 and SD B 330 may communicate with the CASD 310 through a designated interface (e.g., a sharable interface object (SIO)). The SIO may be an interface that provides communication between different secure domains or applets. In the disclosure, SD A 320 and SD B 330, which is a secure domain assigned for a service of a specific external entity, may be referred to as a first secure domain.

According to an embodiment, SD A 320 and SD B 330 (or the first secure domain) may obtain the asymmetric key pair of KEM.PK and KEM.SK of the KEM algorithm from the CASD 310 (or the second secure domain) through the interface. For example, SD A 320 or SD B 330 may invoke an API of the interface (e.g., the SIO) with the CASD 310, thereby requesting decapsulation using at least one key of the KEM asymmetric key pair stored in the CASD 310. The CASD 310 may obtain a random key K as a value resulting from the de-encapsulation using the KEM secret key of the previously implanted KEM asymmetric key pair, and transmit the random key to SD A 320 or SD B 330. The KEM key pair may be long and may take a long time to be newly generated, and SD A 320 and SD B 330 may decrypt a script by using the CASD 310 storing KEM.PK and KEM.SK instead of separately storing the KEM key pair. According to an embodiment, SD A 320 and SD B 330 may use the structure of the legacy cryptosystem as it is without needing to change properties to have the KEM key pair as a secure channel key.

According to an embodiment, the PQC KEM module 360 may include a library, a package, or a module for a KEM algorithm configured in the secure chipset 300. The PQC KEM module 360 may perform key encapsulation or decapsulation of the KEM algorithm, such as Kyber. When a script is received from an external entity for a specific SD (e.g., SD A 320 or SD B 330), the PQC KEM module 360 may decapsulate a ciphertext of a key included in the script by using the secret key KEM.SK of the KEM key pair stored in the CASD 310. The KEM algorithm of the PQC KEM module 360 may be the same as or correspond to a KEM algorithm of the external entity delivering the script, and the CASD 310 may decapsulate the ciphertext, encapsulated by the external entity with the public key KEM.PK, with the secret key KEM.SK.

According to an embodiment, the PQC digital signature verification module 370 may include a library, a package, or a module that provides a signature verification function among PQC digital signature algorithm functions configured in the secure chipset 300. The PQC digital signature verification module 370 may implement a quantum-safe digital signature algorithm, such as Dilithium.

According to an embodiment, the PQC digital signature verification module 370 may verify an authentication certificate included in the script forwarded from the external entity, and may identify that an entity that generates the script is the external entity. The PQC digital signature verification module 370 may obtain a public key in advance from an issuer (e.g., an issuer or CA) that issues the authentication certificate of the external entity in order to verify a digital signature authentication certificate held by the external entity. For example, the public key of the OCE authentication certificate issuer may be implanted in advance into the secure chipset through a process of the secure chipset 300, a process of the electronic device 200, and/or an OTA service operated by the SE owner. Since the external entity electronically signs using a PQC digital signature algorithm and a key, when the authentication certificate is successfully verified using the public key obtained from the authentication certificate issuer, the authentication certificate included in the script may be trusted as being generated by the external entity not attacked by a quantum computer.

According to an embodiment, the PQC digital signature verification module 370 may verify a digital signature included in the script forwarded from the external entity, and may identify that the script is signed by the authenticated external entity. The PQC digital signature verification module 370 may verify the validity of the digital signature, based on the public key extracted from the authentication certificate of the script.

A PQC algorithm has a large key size and a slow operation speed, while an algorithm for verifying an authentication certificate and a digital signature may be relatively faster and consume less memory than other PQC algorithms. Therefore, verifying the authentication certificate and the digital signature using the PQC digital signature verification module 370 may consume fewer resources and be quantum-safe.

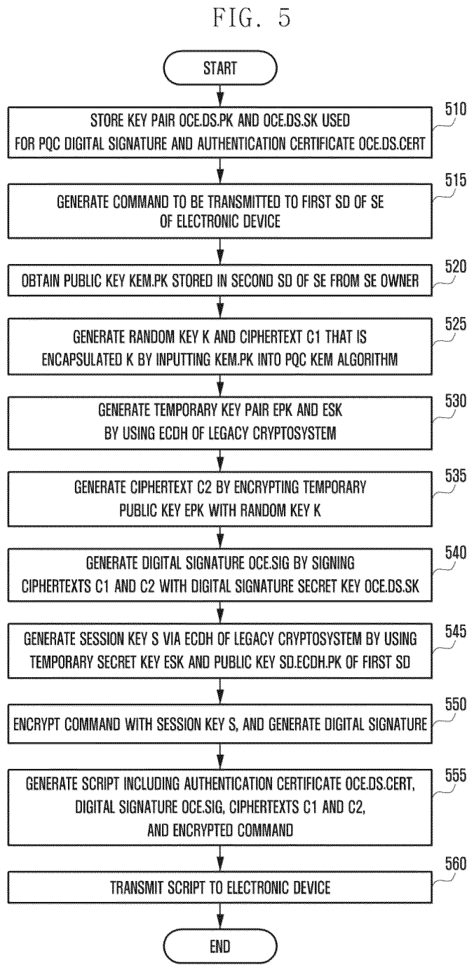

FIG. 5 is a flowchart illustrating a method in which an external entity generates a script according to one or more embodiments.

The method illustrated in FIG. 5 may be performed by an external entity (or an off-card (OCE) entity) (e.g., the external entity 400 of FIG. 2) positioned outside a secure chipset (e.g., the secure chipset 300 of FIG. 3 and FIG. 4) of an electronic device. Hereinafter, a description of the foregoing technical features may be omitted.

According to an embodiment, the external entity may be an entity outside the electronic device that wishes to perform secure communication with a target secure domain (e.g., a first secure domain) among a plurality of secure domains included in the secure chipset (secure element) of the electronic device. For example, the external entity may be a service provider (e.g., a transportation card company and an ID management server) or a server device operated by an owner of the secure chipset (e.g., a manufacturer of the electronic device). The external entity may include at least one server device, and each operation of the method of FIG. 5 may be performed by one server device or two or more server devices included in the external entity.

According to an embodiment, the external entity may perform a plurality of operations through the at least one server device, and may thus have no restriction on computing resources, such as a memory and a processor, and/or computing power. Therefore, unlike the electronic device having limited resources, the external entity may utilize sufficient resources to operate a post-quantum cryptography (PQC) algorithm.

In the following embodiments, operations may be sequentially performed, but are not necessarily performed sequentially. For example, the order of the operations may be changed, or at least two operations may be performed in parallel.

According to an embodiment, in operation 510, the external entity may store a key pair (e.g., a public key OCE.DS.PK and a secret key OCE.DS.SK) used for a PQC digital signature (DS) and an authentication certificate OCE.DS.CERT for the keys.

According to an embodiment, in operation 515, the external entity may generate a command to be transmitted to the first secure domain (SD) of the secure chipset (secure element: SE) of the electronic device. According to an embodiment, the secure chipset of the electronic device may include the plurality of secure domains, and the electronic device may assign any one (e.g., the first secure domain) of the plurality of secure domains to store data of a service provided by the external entity. The command generated by the external entity may include pieces of secure data, such as an applet related to the service provided by the external entity and secure operations of configuring a policy and implanting or obtaining a necessary value.

According to an embodiment, in operation 520, the external entity may obtain a public key KEM.PK stored in a second secure domain of the secure chipset from an owner of the secure chipset. The second secure domain may be a controlling authority security domain (CASD). For example, the CASD may manage operations of generating, deleting, and updating another secure domain in the secure chipset, may be responsible for key management in the secure chipset, and may distribute a key to another secure domain. The CASD may generate an initial key to a newly generated secure domain, or may provide a signature for attestation when providing attestation of a secure chipset of a service applet of another secure domain to the external entity. The second secure domain will be described as a CASD in the disclosure but is not limited thereto, and a secure domain into which a PQC KEM key pair is implanted, other than the CASD, may operate as the second secure domain.

According to an embodiment, the second secure domain (or CASD) may store an asymmetric key pair of a public key KEM.PK and a secret key KEM.SK used in a PQC key encapsulation mechanism (KEM) algorithm not calculable by a quantum computer. The PQC KEM key pair may be generated by an SE owner, such as a manufacturer of the electronic device, and be implanted in a process of the electronic device. For example, the SE owner may implant the same PQC key pair as static keys into secure chipsets of a plurality of electronic devices by the model of each electronic device or the operating system of each SE card. According to an embodiment, the PQC KEM asymmetric key pair may be implanted into the second secure domain in the process of the electronic device, or may be received by an over-the-air (OTA) method while the electronic device is used by a user and be implanted into the second secure domain.

According to an embodiment, the external entity may obtain the public key KEM.PK by making a request to the SE owner (or SE chip vendor). The SE owner may use a static key by the model of each electronic device or by the operating system of each SE card, and may provide a public key KEM.PK corresponding to the model of an electronic device or the operating system of an SE card to the external entity through a secure path in response to a request from the external entity.

According to an embodiment, in operation 525, the external entity may input the obtained public key KEM.PK into the PQC key encapsulation mechanism (KEM) algorithm, thereby generating a random key K and a ciphertext c1 that is encapsulated K.

According to an embodiment, in operation 530, the external entity may generate a temporary key pair including a public key ePK and a secret key eSK by using an elliptic curve Diffie-Hellman (ECDH) algorithm of a legacy cryptosystem. The ECDH algorithm is based on elliptic curve cryptography (ECC), and may be a key exchange protocol used to exchange keys for secure communication. For example, according to the ECDH key exchange protocol, a sender and a receiver of a message may each generate a private key and a public key and may exchange the public keys with each other, the sender may calculate a shared key by using the private key thereof and the public key obtained from the receiver, the receiver may calculate a shared key by using the private key thereof and the public key obtained from the sender, and the sender and the receiver may generate the same session key by inputting each shared key into a key derivation function (KDF). The ECDH algorithm is based on the legacy cryptosystem, and may thus be deciphered using a quantum computer. Although the disclosure shows that the external entity generates the temporary key pair of ePK and eSK by using the ECDH algorithm, the disclosure is not limited thereto and may use an asymmetric key generation method of other legacy cryptosystems.

According to an embodiment, in operation 535, the external entity may encrypt the temporary public key ePK with the random key K, thereby generating a ciphertext c2. For example, to encrypt ePK, the external entity may use a symmetric key block cipher algorithm, such as an advanced encryption standard (AES), and may employ a method, such as cipher block chaining (CBC) and Galois Counter mode (GCM), as a mode of operation for operating the block cipher algorithm. The ECDH public key ePK is not quantum-safe, but is encrypted with the random key K and may thus not be exposed even by an attack by a quantum computer.

According to an embodiment, in operation 540, the external entity may sign the ciphertexts c1 and c2 with the digital signature secret key OCE.DS.SK, thereby generating a digital signature OCE.sig. The digital signature secret key OCE.DS.SK may be a key stored in advance before generation of a script in operation 510.

According to an embodiment, since the ciphertexts c1 and c2 are generated using the quantum-safe PQC KEM algorithm and the symmetric key cipher algorithm, the random key K and the ECDH public key ePK may be safely protected from an attack by a quantum computer. Further, since the external entity signs with the quantum-safe signature algorithm using the digital signature secret key OCE.DS.SK, the receiver (e.g., the secure chipset of the electronic device) to receive the script may trust that the ciphertexts c1 and c2 are generated only by an entity holding the secret key OCE.DS.SK.

According to an embodiment, in operation 545, the external entity may generate a session key s via ECDH of the legacy cryptosystem by using the temporary secret key eSK and a public key SD.ECDH.PK of the first secure domain. A method by which the external entity generates the session key s may include a method of generating a session key using ECDH in a script method of the legacy cryptosystem. For example, the external entity may generate a shared key by inputting the temporary secret key eSK generated by the external entity and the public key SD.ECDH.PK generated by the first secure domain into the ECDH algorithm, and may generate the session key s by inputting the shared key into the KDF. The session key s may be used to encrypt a message in a session for transmitting the generated command with the secure chipset (or first secure domain) of the electronic device, and when a new session is formed to transmit a new command, the external entity may generate a new session key by repeating at least some of operation 530 to operation 545. According to an embodiment, an external attacker is unable to discover the ECDH public key ePK, which is encrypted by a quantum-safe method, and is thus unable to calculate the session key s.

According to an embodiment, in operation 550, the external entity may encrypt the command with the generated session key s, and may generate a digital signature. As a method by which the external entity encrypts the command and electronically signs, a script generation method (e.g., Global Platform Secure Channel Protocol 11c (GP SCP11c), a secure element management system (SEMS), and local card contents management (LCCM)) of the legacy cryptosystem may be used. According to an embodiment, since the session key s is used for symmetric key encryption, the receiver (e.g., the secure chipset of the electronic device) may decrypt the encrypted command through the same session key s.

According to an embodiment, in operation 555, the external entity may generate a script including the authentication certificate OCE.DS.CERT, the digital signature OCE.sig, the ciphertexts c1 and c2, and the encrypted command. The external entity may generate the script by combining pieces of data included in the script into a form parsable by the receiver (e.g., the secure chipset of the electronic device) of the script.

According to an embodiment, in operation 560, the external entity may transmit the generated script to the electronic device. For example, the external entity may transmit the script to the electronic device through a wireless network by the OTA method.

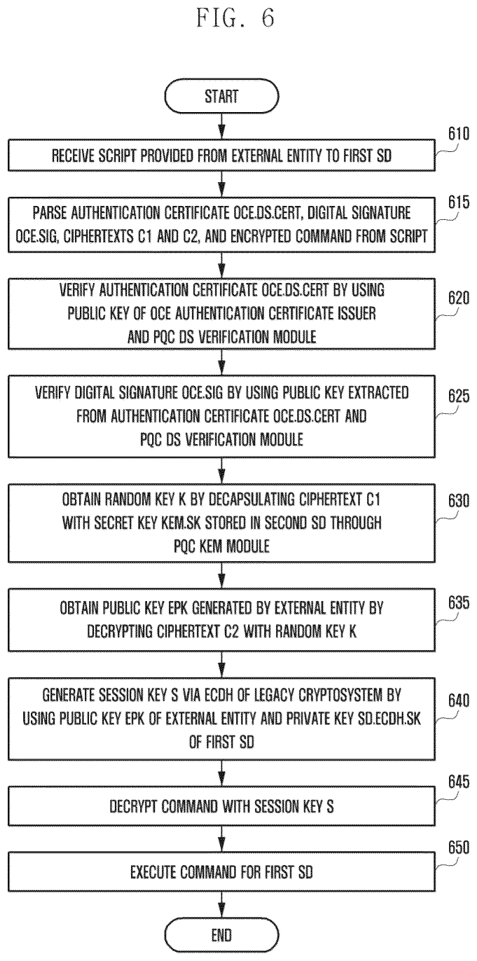

FIG. 6 is a flowchart illustrating a method in which an electronic device processes a script according to one or more embodiments.

The method illustrated in FIG. 6 may be performed by an electronic device (e.g., the electronic device of FIG. 3). Hereinafter, a description of the foregoing technical features may be omitted.

According to an embodiment, the electronic device may include a secure chipset, and the secure chipset may include a plurality of domains. According to an embodiment, among the plurality of secure domains, a first secure domain may be a secure domain assigned to store data related to a service of an external entity. A second secure domain may be a controlling authority security domain (CASD) responsible for generating and managing other secure domains within the secure chipset and responsible for key management, but is not limited to the CASD. According to an embodiment, the second secure domain may store an asymmetric key pair of KEM.PK and KEM.SK of a PQC KEM algorithm.

In the following embodiments, operations may be sequentially performed, but are not necessarily performed sequentially. For example, the order of the operations may be changed, or at least two operations may be performed in parallel.

According to an embodiment, in operation 610, the electronic device may receive a script provided from the external entity to the first secure domain. For example, the electronic device may receive the script from the external entity through a wireless network by an OTA method by using a wireless communication circuit (e.g., the wireless communication circuit of FIG. 3). Here, the external entity may be a service provider (e.g., a transportation card company and an ID management server) or a server device operated by an owner of the secure chipset (e.g., a manufacturer of the electronic device).

According to an embodiment, in operation 615, the electronic device may parse an authentication certificate OCE.DS.CERT, a digital signature OCE.sig, ciphertexts c1 and c2, and an encrypted command of the external entity from the received script.

According to an embodiment, in operation 620, the electronic device may verify the authentication certificate OCE.DS.CERT by using a public key of an OCE authentication certificate issuer and a PQC digital signature verification module. For example, to verify the digital signature authentication certificate held by the external entity, the electronic device may obtain the public key in advance from the issuer (e.g., an issuer or CA) that issues the authentication certificate of the external entity. Since the external entity electronically signs using a PQC digital signature algorithm and a key, the authentication certificate OCE.DS.CERT may be trusted not to be attacked by a quantum computer. Therefore, when successfully verifying the authentication certificate OCE.DS.CERT, the electronic device may authenticate the received script as being generated by the external entity. According to an embodiment, the authentication certificate OCE.DS.CERT may include the public key to the digital signature.

According to an embodiment, in operation 625, the electronic device may verify the digital signature OCE.sig by using the public key extracted from the authentication certificate OCE.DS.CERT and the PQC digital signature verification module. When verification is successful, the electronic device may trust that the signature is made by the external entity that is an entity authenticated in operation 620.

According to an embodiment, in operation 630, the electronic device may decapsulate the ciphertext c1 with the secret key KEM.SK stored in the second secure domain through a PQC KEM module, thereby obtaining a random key K. According to an embodiment, the first secure domain may invoke an API of an interface (e.g., a sharable interface object (SIO)) with the second secure domain, thereby obtaining the secret key KEM.SK of the PQC KEM key pair stored in the second secure domain. The PQC KEM key pair stored in the second secure domain may be static keys implanted in a manufacturing process or by an OTA method.

According to an embodiment, the ciphertext c1 may be an encapsulation of the random key K generated by the external entity inputting the public key KEM.PK into a PQC key encapsulation mechanism (KEM), and the PQC KEM module stored in the secure chipset of the electronic device may decapsulate the ciphertext c1 by the same PQC KEM algorithm as that of the external entity.

According to an embodiment, in operation 635, the electronic device may decrypt the ciphertext c2 with the random key K, thereby obtaining a public key ePK generated by the external entity. The public key ePK of a temporary ECDH key pair generated by the external entity may be encrypted with the random key K after being generated, and then be decrypted within the secure chipset of the electronic device, thus being quantum-safe. Therefore, the public key ePK is not exposed to the outside, and may be safe from an attack by a quantum computer on the ECDH (or ECC) key pair.

According to an embodiment, in operation 640, the electronic device may generate a session key s via ECDH of a legacy cryptosystem by using the public key ePK of the external entity and a private key SD.ECDH.SK of the first secure domain. The external entity may generate a session key s by using a temporary secret key eSK and a public key SD.ECDH.PK of the first secure domain, and a ciphertext of the command included in the script may be encrypted with the session key s generated by the external entity. Since the electronic device generates the session key s by using the public key ePK of the external entity and a private key SD.ECDH.SK of the first secure domain via the same ECDH algorithm as that of the external entity, the session key s generated by the electronic device may be the same as the session key s generated by the external entity.

According to an embodiment, in operation 645, the electronic device may decrypt the encrypted command with the generated session key s. Since the command is encrypted by a symmetric key method using the session key s and the electronic device generates the same session key s as that of the external entity in operation 640, the command may be decrypted using the generated session key s.

According to an embodiment, a process in which the electronic device generates the session key and decrypts the command may use a method of the legacy cryptosystem instead of using a PQC system. Therefore, even though including only the configuration of the legacy cryptosystem not including quantum-safe hardware and/or software to generate the session key and decrypt the command, the electronic device may provide a quantum-safe environment in which the script is not exposed by an attack by a quantum computer.

According to an embodiment, in operation 650, the electronic device may execute the command for the first secure domain. For example, the electronic device may install and operate an applet configured in the command, and/or may execute a policy configured in the command.

An electronic device according to one or more embodiments of the disclosure may include a communication circuit, a secure chipset, and a processor operatively connected to the communication circuit and the secure chipset.

According to an embodiment, the secure chipset may include a plurality of secure domains including a first secure domain and a second secure domain and a PQC digital signature verification module configured to verify a digital signature based on a post-quantum cryptography system.

According to an embodiment, the processor may be configured to receive a script forwarded from an external entity to the first secure domain among the plurality of secure domains through the communication circuit, obtain an authentication certificate and a digital signature of the external entity by parsing the script, verify the obtained authentication certificate of the external entity through the PQC digital signature verification module by using a first authentication key related to the authentication certificate of the external entity stored in advance in the first secure domain, extract a second authentication key from the authentication certificate of the external entity, and identify validity of the digital signature by using the second authentication key through the PQC digital signature verification module.

According to an embodiment, the secure chipset may further include a post-quantum cryptograph (PQC) key encapsulation mechanism (KEM) module configured to execute a KEM algorithm based on the post-quantum cryptography system.

According to an embodiment, the second secure domain may store a KEM public key and a KEM secret key used for the KEM algorithm.

According to an embodiment, the first secure domain may not store the keys used for the KEM algorithm.

According to an embodiment, the KEM public key and the KEM secret key may be static keys implanted in a process of the electronic device.

According to an embodiment, the script may further include a first ciphertext, and the processor may be configured to obtain a random key by decapsulating the first ciphertext with the KEM secret key through the PQC KEM module when the digital signature of the external entity is identified as being valid.

According to an embodiment, the script may further include a second ciphertext and an encrypted command, and the processor may be configured to obtain an elliptic curve Diffie-Hellman (ECDH) public key of the external entity by decrypting the second ciphertext with the obtain random key, generate a session key through an ECDH algorithm by using the obtained ECDH public key of the external entity and an ECDH private key stored in the first secure domain, and decrypt the encrypted command with the session key.

According to an embodiment, an operation of obtaining the ECDH public key of the external entity and an operation of generating the session key may be based on an algorithm of a legacy cryptosystem.

A secure data processing method of an electronic device according to one or more embodiments of the disclosure may include receiving a script forwarded from an external entity to a first secure domain among a plurality of secure domains of a secure chipset of the electronic device, obtaining an authentication certificate and a digital signature of the external entity by parsing the script, verifying the obtained authentication certificate of the external entity through a PQC digital signature verification module by using a first authentication key related to the authentication certificate of the external entity stored in advance in the first secure domain, extracting a second authentication key from the authentication certificate of the external entity, and identifying validity of the digital signature by using the second authentication key through the PQC digital signature verification module.

According to an embodiment, the secure chipset may further include a post-quantum cryptograph (PQC) key encapsulation mechanism (KEM) module configured to execute a KEM algorithm based on a post-quantum cryptography system.

According to an embodiment, the second secure domain may store a KEM public key and a KEM secret key used for the KEM algorithm.

According to an embodiment, the first secure domain may not store the keys used for the KEM algorithm.

According to an embodiment, the KEM public key and the KEM secret key may be static keys implanted in a process of the electronic device.

According to an embodiment, the script may further include a first ciphertext, and the method may further include obtaining a random key by decapsulating the first ciphertext with the KEM secret key through the PQC KEM module when the digital signature of the external entity is identified as being valid.

According to an embodiment, the script may further include a second ciphertext and an encrypted command, and the method may further include obtaining an elliptic curve Diffie-Hellman (ECDH) public key of the external entity by decrypting the second ciphertext with the obtain random key, generating a session key through an ECDH algorithm by using the obtained ECDH public key of the external entity and an ECDH private key stored in the first secure domain, and decrypting the encrypted command with the session key.

According to an embodiment, the obtaining of the ECDH public key of the external entity and the generating of the session key may be based on an algorithm of a legacy cryptosystem.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that one or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a communication circuit;
a secure chipset;
at least one memory storing one or more instructions; and
at least one processor operatively connected to the at least one memory, the communication circuit and the secure chipset,
wherein the secure chipset is configured to execute the one or more instructions to:
provide a plurality of secure domains comprising a first secure domain and a second secure domain, and
verify a digital signature based on a post-quantum cryptography system, and
wherein the at least one processor is configured to execute the one or more instructions to cause the electronic device to:
receive a script forwarded from an external entity to the first secure domain through the communication circuit,
obtain an authentication certificate and a digital signature of the external entity by parsing the script,
cause the secure chipset to verify the obtained authentication certificate of the external entity by using a first authentication key related to the authentication certificate of the external entity stored in the first secure domain;
extract a second authentication key from the authentication certificate of the external entity; and
cause the secure chipset to validate the digital signature by using the second authentication key.

2. The electronic device of claim 1, wherein the secure chipset is further configured to execute the one or more instructions to:
execute a key encapsulation mechanism (KEM) algorithm based on a post-quantum cryptography system.

3. The electronic device of claim 2, wherein the second secure domain stores a KEM public key and a KEM secret key used for the KEM algorithm.

4. The electronic device of claim 3, wherein the first secure domain does not store keys used for the KEM algorithm.

5. The electronic device of claim 3, wherein the KEM public key and the KEM secret key are static keys implanted in a manufacturing process of the electronic device.

6. The electronic device of claim 3,
wherein the script comprises a first ciphertext, and
wherein the at least one processor is configured to execute the one or more instructions to:
based on the digital signature of the external entity being identified as being valid, obtain a random key by decapsulating the first ciphertext with the KEM secret key through the KEM algorithm executed by the secure chipset.

7. The electronic device of claim 6,
wherein the script further comprises a second ciphertext and an encrypted command, and
wherein the at least one processor is configured to execute the one or more instructions to:
obtain an elliptic curve Diffie-Hellman (ECDH) public key of the external entity by decrypting the second ciphertext with the random key,
generate a session key through an ECDH algorithm by using the ECDH public key and an ECDH private key stored in the first secure domain, and
decrypt the encrypted command with the session key.

8. The electronic device of claim 7, wherein an operation of obtaining the ECDH public key and an operation of generating the session key are based on an algorithm of a legacy cryptosystem.

9. A secure data processing method of an electronic device, the method comprising:
receiving a script forwarded from an external entity to a first secure domain among a plurality of secure domains of a secure chipset of the electronic device;
obtaining an authentication certificate and a digital signature of the external entity by parsing the script;
causing the secure chipset to verify the obtained authentication certificate of the external entity by using a first authentication key related to the authentication certificate of the external entity stored in the first secure domain;
extracting a second authentication key from the authentication certificate of the external entity; and
causing the secure chipset to validate the digital signature by using the second authentication key.

10. The method of claim 9, further comprising:
causing the secure chipset to execute a key encapsulation mechanism (KEM) algorithm based on a post-quantum cryptography system.

11. The method of claim 10, wherein a second secure domain of the secure chipset stores a KEM public key and a KEM secret key used for the KEM algorithm.

12. The method of claim 11, wherein the first secure domain does not store keys used for the KEM algorithm.

13. The method of claim 11, wherein the KEM public key and the KEM secret key are static keys implanted in a manufacturing process of the electronic device.

14. The method of claim 11,
wherein the script comprises a first ciphertext, and
wherein the method further comprises, based on the digital signature of the external entity being identified as being valid, obtaining a random key by decapsulating the first ciphertext with the KEM secret key by executing the KEM algorithm through the secure chipset.

15. The method of claim 14, wherein the script further comprises a second ciphertext and an encrypted command, and
wherein the method further comprises:
obtaining an elliptic curve Diffie-Hellman (ECDH) public key of the external entity by decrypting the second ciphertext with the random key;
generating a session key through an ECDH algorithm by using the ECDH public key and an ECDH private key stored in the first secure domain; and
decrypting the encrypted command with the session key.

16. The method of claim 15, wherein the obtaining of the ECDH public key and the generating of the session key are based on an algorithm of a legacy cryptosystem.

17. A non-transitory computer readable medium having instructions stored therein, which when executed by at least one processor cause the at least one processor to execute a method of securely processing data processing by an electronic device, the method comprising:
receiving a script forwarded from an external entity to a first secure domain among a plurality of secure domains of a secure chipset of the electronic device;
obtaining an authentication certificate and a digital signature of the external entity by parsing the script;
causing the secure chipset to verify the obtained authentication certificate by using a first authentication key related to the authentication certificate of the external entity stored in the first secure domain;
extracting a second authentication key from the authentication certificate of the external entity; and
causing the secure chipset to validate the digital signature by using the second authentication key.

18. The non-transitory computer readable medium of claim 17, wherein the method further comprises:
causing the secure chipset to execute a key encapsulation mechanism (KEM) algorithm based on a post-quantum cryptography system.

19. The non-transitory computer readable medium of claim 17, wherein a second secure domain of the secure chipset stores a KEM public key and a KEM secret key used for the KEM algorithm.

20. The non-transitory computer readable medium of claim 19,
wherein the script comprises a first ciphertext, and
wherein the method further comprises, based on the digital signature of the external entity being identified as being valid, obtaining a random key by decapsulating the first ciphertext with the KEM secret key by executing the KEM algorithm through the secure chipset.
